(19) United States
(12) Patent Application Publication
(10) Pub. No.: US 2004/0157588 A1
(43) Pub. Date: Aug. 12, 2004

(54) Method and arrangement for managing information in a communication device

(76) Inventors: Peter Alexander Stepman, Berlin (DE); Riitta Nieminem-Sundell, Helsinki (FI)

Correspondence Address: BANNER & WITCOFF, 1001 G STREET N W, SUITE 1100, WASHINGTON, DC, 20001, US

(21) Appl. No.: 10/475,742

(22) PCT Filed: Apr. 24, 2001
(86) PCT No.: PCT/FI01/00392

(51) Int. Cl. H04Q 7/20

(52) U.S. Cl. 455/414.1; 455/550.1; 455/435.2

(57) ABSTRACT

The invention generally relates to managing communications in a communication device. Especially the invention concerns prioritising the communications. The objects of the invention are achieved by determining a priority value to counterparts of communication (101) and by allowing the user to select a priority level or “mode” (102). The information relating to the counterparts are processed or given to the user on the basis of the priority value and the mode (106, 109, 120). The user can easily change the currently applied mode and thus adjust the information flow to be suitable for each situation (102, 110). The counterpart may be either a recipient or a source of communication. The invention is advantageously applied in mobile communicators.

The invention generally relates to managing communications information in a communication device. Especially the invention concerns prioritising the communications information.

Communication devices are nowadays used for many types of communication. Except for ordinary voice calls, the devices are used e.g. for transmitting/receiving SMS (Short Message Service) short messages, electronic mail, voice mail, and for browsing the Internet The user may regularly receive information or calls from a large number of sources. As well, there may be a large number of recipients, whom a user regularly transmits information or calls to. This leads to a problem, how to manage large amounts of communication data in such a way that the overflow of incoming information does not disturb the user, and that the user can still communicate efficiently in different situations. For example, it may be necessary to refuse some of the incoming calls or to arrange that all of the incoming information will not always appear in the terminal display.

To solve this problem it has been found useful for example, to inform the recipient of a telephone call about the identity of the caller. In digital telephone systems, the Calling subscriber Line Identity or CLI number of the caller's telephone is added as a part of the message as a part of the message that indicates the incoming request for call establishment to the intended recipient's telephone. Known ways for utilizing the received CLI number at the receiving end are displaying it to the user, converting it to a name or other alphanumeric identifier fetched from a memory and displaying the conversion result to the user, comparing the CLI number to a list of pre-programmed identification rules and selectively refusing or accepting the call depending on the comparison result, or selecting a pre-programmed ringing tone according to who is calling.

However, these CLI applications have some deficiencies. During a day there may be periods when the telephone user may have time to receive calls from a certain caller, and there may be other periods, when the user does not have time to chat with this caller. It would be difficult to program the telephone to refuse/accept a call or to program a different ringing tone for each possible caller for each period of the day.

In electronic mail and pager systems there are prior art solutions where a priority field is included in transmitted messages. The receiving communication device may then process the high priority messages in a different manner than messages with normal priority. This kind of solutions are described eg. in documents [1] WO 9913597, [2] U.S. Pat. No. 5,377,354 and [3] U.S. Pat. No. 6,147,977. However, similar drawbacks are related to these solutions as were described above. So the prior art solutions are not very helpful in managing the large amounts of communication.

It is an object of the present invention to provide a method and an arrangement for managing communications information in a communication device so that problems related to the prior art methods would be solved. It is a further object of the invention to present a method and an arrangement for providing efficient use of the communication device in different user situations, and avoiding disturbance caused by excess of information.

The objects of the invention are achieved by determining a priority value to counterparts of communication, and by allowing a user to select a priority level or “mode”. Information relating to the counterparts is processed or given to the user on the basis of the priority value and the priority level. The user can easily change the currently applied priority level and adjust the information flow to be suitable for each situation. The counterpart may be either a recipient or a source of communication.

The invention can advantageously be implemented as a way to modulate connectability and information inflow/outflow, i.e. communication “volume”, in mobile terminals. The highest volume or lowest priority level would mean that the user accepts calls and information from all sources. The user also has a list of all potential recipients of calls or information available. As the user moves down from its highest level of volume, or higher from its lowest priority level, the device would start to fade out those groups, people, sources and recipients of information that the user does not allow an incoming/outgoing access at such a situation. At the lowest level of volume, or the highest level of priority, only those most important people and information sources are highlighted and given access to the user's terminal.

The invention can also be implemented as a way to view the documents in the terminal memory. The highest volume (or lowest priority level) would mean that all documents are displayed to the user, and the lowest volume (or highest priority level) would mean that only documents that are marked with high priority are displayed.

The invention gives a solution for controlling information flow, wherein the information will not appear in the terminal unsolicited. Instead, users will be requested—either as a one-time request or a request for a constant flow, such as being on a mailing list. At the point of request or originator definition, by entering a contact person in phone book, the end-user decides the priority level of the accepted information. Then the user is able to move between priority levels according to the user's current situations.

A counterpart of communication may be distinguished by caller information, author information or service information, so priority values can also be related to any of these. A calling party or source of information may transmit some additional information about itself or about the type of service at the call setup phase, during the call, or within a message. In this context, “additional” means such information that does not form a part of a routine call setup request like the CLI number. A receiving party (a user) may then use this information for determining a correct priority value for the communication.

It is also possible that some counterparts act as “traditional” counterparts that are not affected by the prioritising/dimmer function even if this function would be activated. There may, for example, be a specific priority value with a meaning that the counterpart is handled as a “traditional” counterpart.

The present invention is characterised by the features of the independent claims:

A method according to the invention of providing information to a user of a communication device, is characterised in that the method comprises steps of:

maintaining in the communication device at least two different priority values;

determining one priority value from the at least two different priority values maintained in the communication device for at least one communication counterpart;

maintaining in the communication device at least two predetermined dynamically selectable modes;

providing information to the user of the communication device, the information being prioritised by comparing currently effective predetermined mode with the priority value for respective counterpart of communication.

The invention also applies to an arrangement in a communication device, which is characterised in that it comprises:

a transceiver unit for communicating with each respective counterpart;

a memory unit (201) for storing general information of each respective communication counterpart;

a user interface for outputting available information (205);

a processor (202); and

software means operative on the processor for:

maintaining in the storage device a database for determining currently effective predetermined mode of the communication device;

comparing priority value of respective communication counterpart with the currently effective predetermined mode of the telecommunications device; and

outputting available information on the user interface, said available information being prioritised by said comparing of the priority value of respective communication counterpart with currently effective predetermined mode of the communication device.

The invention also applies to a computer program, which is characterised in that the program comprises instructions for controlling a communication device or components thereof to implement the inventive method.

The invention also applies to a mobile terminal, which is characterised in that it has a dimmer key or keys for selecting at least two different priority values and/or at least two predetermined dynamically selectable modes.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

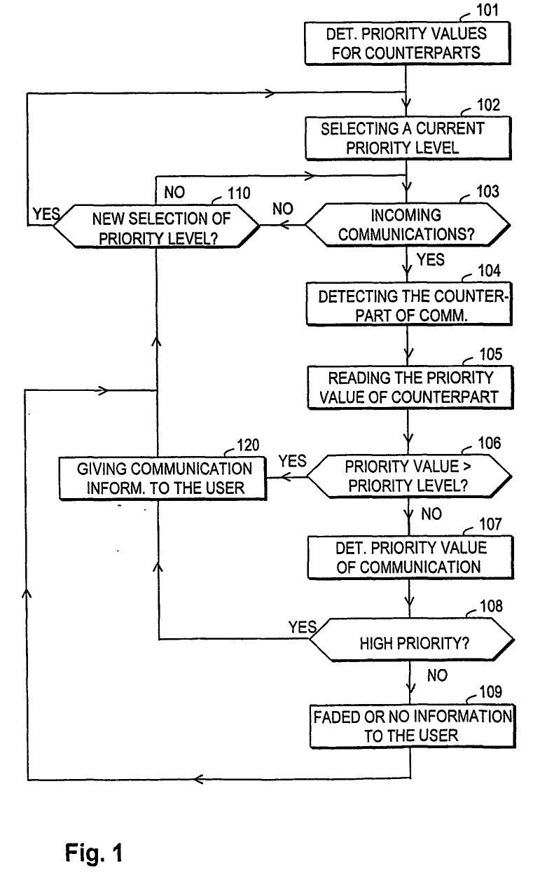

FIG. 1 illustrates a flow diagram of an exemplary method according to the invention, and

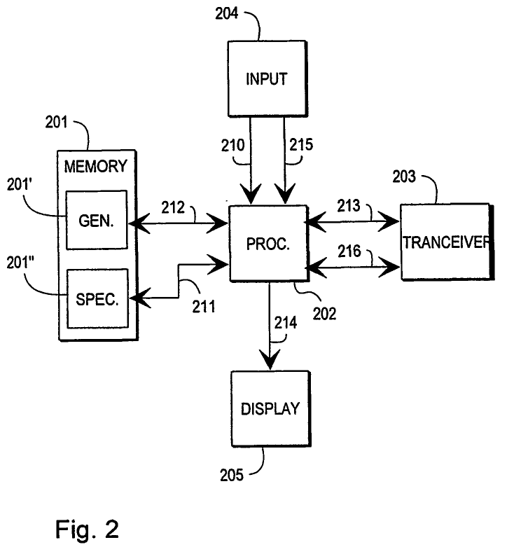

FIG. 2 illustrates a block diagram of an exemplary communication device according to the invention.

FIG. 1 illustrates a flow diagram of an exemplary method according to the invention. A user first determines priority values to counterparts, 101. These priority values are stored in a terminal device related to identity information of each counterpart. There may be just a few priority values such as “low”, “normal” and “high”, or there may be a larger scale of values available, such as values 1 . . . 10. The identity information may include subscriber information such as name, telephone number or URL address. Alternatively the identity information may also include a service type or identity of the caller/sender, or author of a message. The priority values are preferably given to all counterparts that are listed in the memory of the communication device. However, it is also possible that no priority value is given to counterparts of “normal priority”, or alternatively, to counterparts of lowest priority.

The user then selects a priority level that is most suitable for the current situation and surroundings of the user, 102. The selectable priority levels may be corresponding to the selectable priority values, e.g. “low”, “normal” and “high”.

When there is an incoming call or message, 103, a counterpart of the communication is detected, 104. The priority value that corresponds to the counterpart is then read from the memory of the communication device, 105. If the priority value of the counterpart is higher or as high as the selected priority level, the incoming communication is informed to the user, 120. If the priority value of the counterpart is lower than the selected priority level, a possible priority value of the communication (e.g. call or message) is detected, 107. If the incoming communication is of high priority, the incoming communication is informed to the user, 120. If the incoming communication is not of high priority, the incoming communication is informed to the user as faded or not at all, 109. The user can select a new priority level whenever the situation or surroundings of the user changes, 110. In other embodiments of the invention the priority level or mode may change in other ways. For example, the mode may be determined automatically on the basis of present location, time, date and/or events stored in a user's calendar.

A corresponding method as illustrated in FIG. 1 can also be used in a transmission of messages or initiating calls. In one embodiment of the invention there is a telephone book stored in the communication device, which is a list of counterparts with associated priority values. When a user initiates a call or sends a message the user selects a recipient from the telephone book. If the user has selected the highest priority level, the display of the user interface only shows a list of those counterparts with the highest priority value. Alternatively the counterparts with lower priority values may be displayed with a faded text. This way the user can easily select the counterpart with high priority in a situation where the user has selected a high priority level. The information on any counterparts with lower priority values is probably not necessary for the user when a high priority level has been selected.

Next table 1 illustrates an example of a basic implementation of the present invention. The table shows five counterparts and their priority values. The implementation includes priority values 1 . . . 4 and priority levels (modes) 1 . . . 4. On priority level 1 the user is given information relating to all counterparts (marked with “X”). On priority level 2 the user is given information relating to those counterparts whose priority value is 2 or higher, i.e. Jukka, father and boss, Information relating to Antti and advertisements is not given to the user (marked with “0”). On priority level 3 the user is given information relating to those counterparts whose priority value is 3 or higher, i.e. Jukka and boss. Information relating to Father, Antti and advertisements is not given to the user. On priority level 4 the user is given information relating to those counterparts whose priority value is 4 or higher, i.e. Jukka and boss. Information relating to Father, Antti and advertisements is not given to the user.

TABLE 1

| | | Priority | Priority | Priority | Priority |
|---|---|---|---|---|---|
| | Priority | level | level | level | level |
| Counterpart | value | (Mode) 1 | (Mode) 2 | (Mode) 3 | (Mode) 4 |
| Antti | 1 | X | 0 | 0 | 0 |
| Jukka | 4 | X | X | X | X |
| Father | 2 | X | X | 0 | 0 |
| Advertisements | 1 | X | 0 | 0 | 0 |
| Boss | 4 | X | X | X | X |

There is a multitude of alternatives, how counterparts with different priorities can be handled. In the following example there are three different values available for a priority: low, normal and high. A user can also select the priority level from corresponding three levels: low, normal and high. Following table shows an example on how incoming messages are displayed when the user has selected priority level “high”.

TABLE 2

| | Priority level of | |
|---|---|---|
| Message | counterpart | Displayed |
| A message from the boss | High | A message from the boss |
| A message from wife | High | A message from wife |
| Employee information | Normal | Employee information |
| A message from sister | Normal | A message from sister |
| Discount offers | Low | — |
| TV guide info | Low | — |

In this example the messages that are originated from counterparts with high and normal priority values are displayed. The messages from counterparts with high priority value are bolded, and the messages from counterparts with normal priority value displayed with smaller font. Next table shows how the incoming messages are displayed when the user has selected priority level “normal” in this example.

TABLE 3

| | Priority level of | |
|---|---|---|
| Message | counterpart | Displayed |
| A message from the boss | High | A message from the boss |
| A message from wife | High | A message from wife |
| Employee information | Normal | Employee information |
| A message from sister | Normal | A message from sister |
| Discount offers | Low | Discount offers |
| TV guide info | Low | TV guide info |

In this case, also the messages from low priority counterparts are displayed, but a smaller font is used. The messages from counterparts with normal priority value are displayed with a normal font. Next table shows how the incoming messages are displayed when the user has selected priority level “low” in this example.

TABLE 4

| | Priority level of | |
|---|---|---|
| Message | counterpart | Displayed |
| A message from the boss | High | A message from the boss |
| A message from wife | High | A message from wife |
| Employee information | Normal | Employee information |
| A message from sister | Normal | A message from sister |
| Discount offers | Low | Discount offers |
| TV guide info | Low | TV guide info |

In this case all the messages are displayed in a similar manner. It would, of course, also be possible to display the messages from counterparts with high priority bolded on this priority level. It could also be possible to have a priority level where messages from counterparts with (normal and/or) high priority would not be displayed at all. This priority level could be used when messages from low priority counterparts are scanned. One should note that the number of priority levels could be different from the number of different priority values, as the priority levels describe functions of a communication device in different situations.

The invention is advantageously applied in e.g. mobile communicators. FIG. 2 illustrates some parts of a communication device, which are essential in implementing the present invention. The device includes a memory unit 201 for storing general programs (201′) for a processor unit 202, and for storing telephone numbers, names and electronic mail addresses and related information on possible communication counterparts (201″). The processing unit 202 processes commands given by the user as well as received and transmitted information. A transceiver unit 203 transmits/receives information such as messages composed/processed by the processing unit, as well as speech and/or data. A user interface of the communication device may include a keyboard 204 or other input means for the user to enter commands, and a display 205 for displaying messages and other information to the user. According to an aspect of the invention the memory unit 201″ contains also priority information characteristic to the communication counterparts, and information on the selectable priority levels as well as the presently selected priority level. The communication device may also include a Subscriber Identity Module (SIM), which can be used for storing user specific information such as information on the counterparts.

Control functions of the communication device are not described in a greater detail. In general, the functions in a communication device are controlled by a controller, which includes processing capacity in the form of microprocessor(s) and memory in the form of memory circuits, as described above. Such arrangements are known as such from the technology of the art. To convert a known communication device into a communication device according to the invention, it is necessary to store into the memory means a set of machine-readable instructions that instruct the microprocessor(s) of the controller to perform the control operations described above. Composing and storing into memory of such instructions involves known technology which, when combined with the teachings of this patent application, is within the capabilities of a person skilled in the art.

Above, an example embodiment of the solution according to the invention has been described. The principle according to the invention can naturally be modified within the frame of the scope defined by the claims, for example, by modification of the details of the implementation and ranges of use.

### CITED REFERENCES

[1] WO 9913597; Method and apparatus for displaying a message, which has been received

[2] U.S. Pat. No. 5,377,354; Method and system for sorting and prioritising electronic mail messages

[3] U.S. Pat. No. 6,147,977; method and apparatus for processing messages based on originator and recipient priorities

1. A method of providing information to a user of a communication device, characterised in that the method comprises steps of:
maintaining in the communication device at least two different priority values;
determining one priority value from the at least two different priority values maintained in the communication device for at least one communication counterpart (101);
maintaining in the communication device at least two predetermined dynamically selectable modes;
providing information to the user of the communication device, the information being prioritised by comparing currently effective predetermined mode with the priority value for respective counterpart of communication (102, 106, 109, 120).

2. A method according to claim 1, characterised in that the step of determining one priority value from the at least two different priority values maintained in the communication device for at least one communication counterpart is made continually.

3. A method according to claim 1, characterised in that it comprises a step of storing said one priority value in the communication device for the at least one communication counterpart.

4. A method according to claim 1, characterised in that the step of determining one priority value from the at least two different priority values maintained in the communication device is made for each respective communication counterpart.

5. A method according to the claim 1, characterised in that the communication is one of following:
short message,
voice call,
voice message,
data connection, and
electronic mail.

6. A method according to claim 1, characterised in that the information is prioritised independent of application type of the information.

7. A method according to claim 1, characterised in that the counterpart is distinguished by its caller/subscriber/recipient information, author information or service information.

8. A method according to claim 1, characterised in that information relating to counterparts, the priority value of which is below a first value determined by the selected mode is not given to the user (109).

9. A method according to claim 1, characterised in that information relating to counterparts, the priority value of which is below a first value determined by the selected mode is given to the user faded (109).

10. A method according to claim 1, characterised in that information relating to counterparts, the priority value of which is above a first value determined by the selected mode is given to the user enhanced (120).

11. A method according to claim 1, characterised in that information relating to counterparts, the priority value of which is above a second value determined by the selected mode is given to the user faded.

12. A method according to claim 1, characterised in that a second priority value, is related to an incoming communication, said second priority value is detected (107), and said information is given to the user by the user interface also on the basis of said second priority value of said incoming communication (108).

13. A method according to claim 1, characterised in that the mode is selected by the user.

14. A method according to claim 1, characterised in that the mode is determined on the basis of present location, time, date and/or events stored in a user's calendar.

15. An arrangement in a communication device, characterised in that it comprises:
a transceiver unit (203) for communicating with each respective counterpart;
a memory unit (201) for storing general information of each respective communication counterpart;
a user interface for outputting available information (205);
a processor (202); and
software means operative on the processor for:
maintaining in the storage device a database for determining currently effective predetermined mode of the communication device;
comparing priority value of respective communication counterpart with the currently effective predetermined mode of the telecommunications device; and
outputting available information on the user interface, said available information being prioritised by said comparing of the priority value of respective communication counterpart with currently effective predetermined mode of the communication device.

16. An arrangement according to the claim 15, characterised in that the software means are operative on the processor for continually comparing said priority value with the currently effective predetermined mode of the telecommunications device.

17. An arrangement according to the claim 15, characterised in the memory unit comprises means for storing a priority value of at least one communication counterpart.

18. An arrangement according to the claim 15, characterised in that the software means are operative on the processor for determining one priority value from the at least two different priority values maintained in the communication device for each respective communication counterpart.

19. An arrangement according to the claim 15, characterised in that the communication is one of following:
short message,
voice call,
voice message,
data connection, and
electronic mail.

20. An arrangement according to the claim 15, characterised in that the software means are operative on the processor for said available information being prioritised independent of application type of the information.

21. An arrangement according to claim 15, characterised in that it comprises means (201, 202, 203) for distinguishing the communication counterpart by its caller/subscriber/recipient information, author information or service information.

22. An arrangement according to claim 15, characterised in that the user interface comprises means (202, 205) for preventing giving to the user information relating to counterparts, the priority value of which is below a first value determined by the selected mode.

23. An arrangement according to claim 15, characterised in that the user interface comprises means (202, 205) for fading the appearance of information relating to counterparts, the priority value of which is below a first value determined by the selected mode is given to the user faded.

24. An arrangement according to claim 15, characterised in that the user interface comprises means (202, 205) for enhancing the appearance of information relating to counterparts, the priority value of which is above a first value determined by the selected mode.

25. An arrangement according to claim 15, characterised in that the user interface comprises means (202, 205) for fading the appearance of information relating to counterparts, the priority value of which is above a second value determined by the selected mode.

26. An arrangement according to claim 15, characterised in that it comprises means (202, 203) for retrieving a second priority value from an incoming communication, and means (202, 205) for giving said information to the user also on the basis of said second priority value of said incoming communication.

27. An arrangement according to claim 15, characterised in that the communication device is a mobile station.

28. A computer program, characterised in that the program comprises instructions for controlling a communication device or components thereof to implement the method according to claim 1.

29. A mobile terminal, characterised in that it has a dimmer key or keys for selecting at least two different priority values and/or at least two predetermined dynamically selectable modes.
